(19) United States
(12) Patent Application Publication
(10) Pub. No.: US 2023/0265980 A1
(43) Pub. Date: Aug. 24, 2023

(54) Convenient Courtesy Lighting (A.K.A Courtesy)

(71) Applicant: James Ogbonna Ugwuogo, Waterloo (CA)

(72) Inventor: James Ogbonna Ugwuogo, Waterloo (CA)

(21) Appl. No.: 18/161,085

(22) Filed: Jan. 29, 2023

Related U.S. Application Data
(60) Provisional application No. 63/304,606, filed on Jan. 29, 2022.

(51) Int. Cl. F21S 8/00; F21V 23/04

(52) U.S. Cl. CPC F21S 8/035; F21V 23/0464; F21V 23/0471; F21Y 2115/10

(57) ABSTRACT

The Product is a lighting system that offers low and gradually increasing luminous intensity to provide ambient lighting in dark spaces or rooms, particularly at night, without requiring the use of a light switch.

Frequently, when individuals wake up during the night to use the bathroom or toilet, they need some form of lighting to navigate around. In such cases, they may use their phone flashlight or turn on the bathroom lights. However, the sudden brightness of these lights can be dangerously blinding, causing them to become fully awake and potentially leading to difficulty falling back asleep.

Convenient Courtesy Lighting, referred to as The Product in this filing, is designed to provide the necessary ambient lighting automatically without significantly affecting the user’s ability to fall back asleep. This is achieved by offering low and gradually increasing luminous intensity, which helps the user navigate their way without being ‘blinded’ by sudden brightness.

The turning off sequence of The Product is designed to gradually dim the lights, providing a soothing and calming effect. This dimming effect is especially useful for the baby crib model, as sudden darkness can startle or frighten a baby, potentially leading to disruptions in sleep. With The Product, the baby can slowly and peacefully fall back to sleep without feeling the sudden loss of light that can occur with traditional light switches.

In fact, some experts believe that a gradual dimming effect can help “lure” the baby back to sleep, as it mimics the natural fading of light that occurs during sunset. This can create a familiar and calming environment that helps the baby feel safe and secure, leading to a more restful sleep.

Overall, The Product’s dimming feature provides a gentle and effective way to help babies fall asleep and stay asleep, without the harshness of traditional light switches. With its gradual and soothing dimming effect, The Product can help both babies and parents get a good night’s rest.

There have been several studies on the effects of light exposure on sleep quality which suggest that bright light exposure before bedtime can delay the circadian clock, making it harder to fall asleep and stay asleep. In contrast, dim light exposure can help promote relaxation and improve sleep quality. While these studies do not specifically address the effects of a gradual dimming effect, they provide insight into the importance of light exposure on sleep and circadian rhythms.

### THE DESIGN

The Product consists of several key components, including a MicroController, a Light Dependent Resistor (LDR) or Light Sensor, a Passive Infra-Red (PIR) Sensor, a set of resistors, and a group of Light Emitting Diodes (LEDs). These elements are arranged in a specific sequence that allows the lightings to be controlled independently, resulting in an increasing or decreasing brightness depending on whether the lighting sequence is being started or turned off, respectively.

A specialized software program is installed on the Microcontroller to regulate the lighting in a forward and reverse progressive order based on the occurrence of two specific conditions simultaneously: the presence of darkness and the detection of motion.

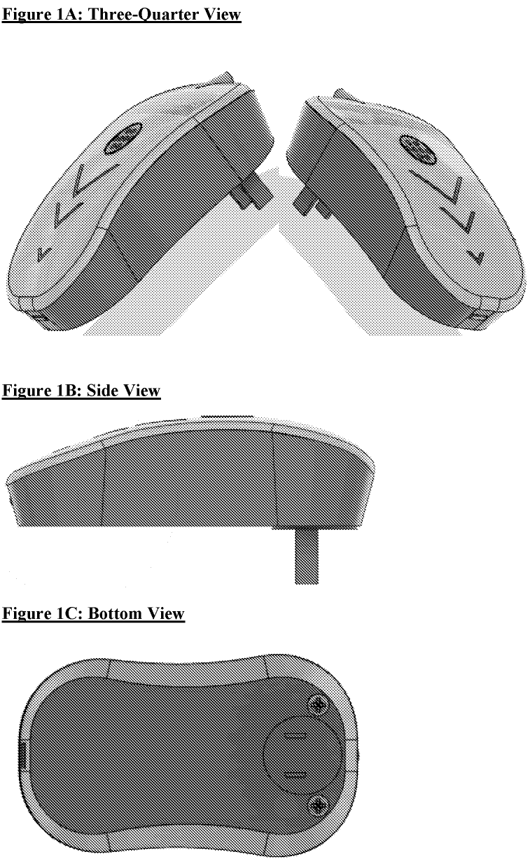

FIG. 1 provides visual representations of The Product through three-quarter (¾) views, a side view, and a bottom view. These pictorial views depict a 3-D model of The Product.

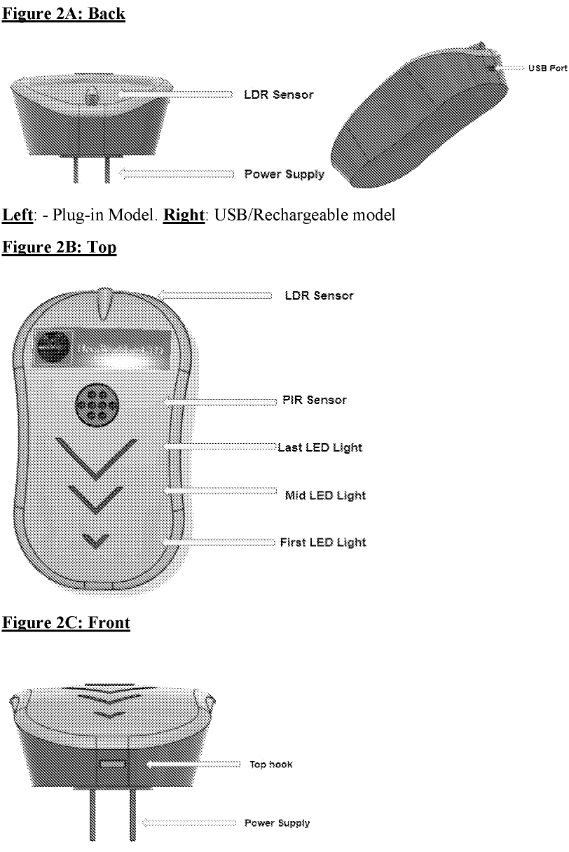

FIG. 2 displays an overview of the packaging of The Product, including the locations of key parts such as the power plug, USB port, LED lights, and sensors. Descriptions for each of these key parts are also provided in the figure.

### UTILITY/USAGE

The Product can be connected to an electrical outlet, either directly to a 110 to 220 volts outlet or through a detachable 5 volts power supply - such as a USB power supply, in various locations around the house, such as the washroom, shed, or storage spaces.

Alternatively, The Product can be powered by rechargeable batteries, eliminating the need for a power outlet. This allows it to be placed in various locations around the house where needed, such as a baby’s crib, bedroom, kitchen, stairways, or walkways.

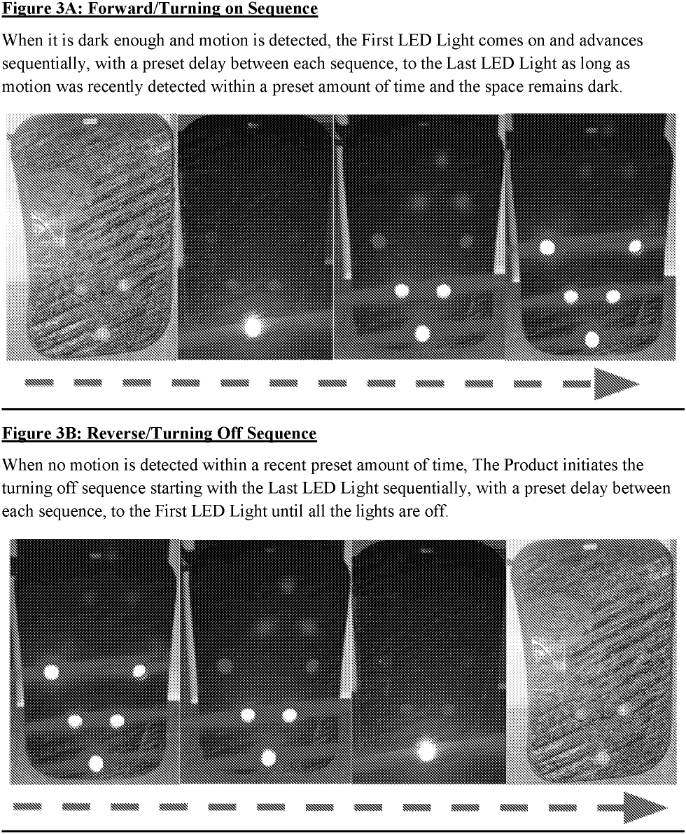

When the light sensor detects that the ambient light has fallen below a predetermined level (either due to nightfall or the lights in the surrounding area being switched off) and the PIR sensor detects the presence of a human or an animal, the product will initiate a forward sequence of lighting. This sequence will start with the first LED light and, after a set duration, the mid LED light will turn on followed by the last LED light. The sequence will continue in this order until all sets of lights are lit, as depicted in FIG. 3.

In the event of a sudden restoration of bright light that exceeds the ambient setting, The Product’s ambient lighting system will turn off within seconds. However, if the other light source is removed, all lights will be restored, within seconds, to their previous states.

When the LED lights are on and no motion is detected, and there is no other light source besides the LED lights, The Product will start turning off the ambient lights in reverse order (Last-In, First-Out (LIFO)) after a predetermined number of seconds, creating a dimming effect within the enclosed space until all lights are turned off.

If motion is detected at any point during the turning off sequence, the sequence will be interrupted and reversed, and the turning on sequence will begin. The sequence will start with the light that was currently on and continue until all the lights are lit again.

The Product’s LED lighting colors will vary based on the model, and can include Blue, Green, White, and Red. Additionally, the product packaging will be available in a range of colors, including monochrome and multi-colored options. The lighting pattern will also come in different shapes, such as ‘V’, dot-matrix, or other shape patterns.

The installation of The Product is straightforward and hassle-free as it can be easily plugged into any existing wall outlet or standard USB charging port for rechargeable models, as depicted in FIG. 1 and FIG. 2, respectively. The Product is a ready to use product with no need for any form of retrofitting.

The baby crib models will be equipped with child-safe features and designed to be installed at a safe distance or location away from the baby. These models will be rechargeable and will have the same functionalities as the other models.

### SPACES USE - PRACTICABILITY OF THE PRODUCT

The product can be used in:
1. Bathrooms
2. Baby cribs
3. Cold rooms
4. Sheds
5. Closets (Walk-in closets;
6. Pantry
7. Bottler rooms
8. Mudrooms
9. Trailers/RVs
10. Walkways/Hallways
11. Hotels; Air BnB, Short stays, Motels

### DETAILED DESCRIPTION OF THE DRAWINGS

In FIG. 1A, an example of how The Product might look after packaging is displayed in a three-quarter view. The colors shown are only examples, and The Product could be monochrome.

In FIG. 1B, The Product is displayed in a side view, while FIG. 1C shows the bottom view and the location of two screws used to secure the top and bottom assemblies.

FIG. 2A displays the back view of The Product, featuring the Light Sensor and the Power Plug - which can either be an AC plug for the plug-in version or a USB port for the rechargeable versions.

FIG. 2B shows the top view of The Product, highlighting the relative location of each light, the PIR sensor, the Light sensor, and the potential location of the company logo.

FIG. 2C displays the front of The Product, showing the plug-in pin for the plug-in version and the hook of the top cover to the bottom cover, which provides additional grip between the two assemblies, in addition to the two screws shown in FIG. 1C.

FIG. 3A demonstrates the lighting-up sequence of The Product with radial LED lighting, progressing from “all off” to “all on” with delays between each subsequent lighting. When motion is detected and the area remains dark enough, the First LED Light turns on and advances sequentially, with a preset delay between each sequence, to the Last LED Light.

FIG. 3B shows the opposite sequence of FIG. 3A, with the LEDs advancing from “all on” to “all off” with the same duration of delays between each as with the “on sequence” of FIG. 3A, progressing from left to right.

The Product will start turning off its LED lights in a specific sequence if there has been no movement detected for a set amount of time. The sequence begins with the last light that was turned on and moves in reverse order until all lights have been turned off. There is a preset delay between each light being turned off.

1. The Product can detect light/darkness and motion and trigger an ambient lighting sequence within their vicinity in dark or enclosed spaces. See ‘Spaces use’ on the next page.

2. The Product can be adapted for child-safe uses in baby cribs.

3. The Product is portable and has a foldable power plug for ease of traveling, making it suitable for use in hotels, Airbnb, short stays, motels, and other similar locations.
